(19) United States
(12) Patent Application Publication
(10) Pub. No.: US 2014/0019831 A1
(43) Pub. Date: Jan. 16, 2014

(54) METHOD FOR TRANSMITTING DATA PACKETS AND CORRESPONDING SYSTEM WITH DATA SOURCE AND DATA SINK

(71) Applicant: KROHNE Messtechnik GmbH, Duisburg (DE)

(72) Inventors: Dirk Kuschnerus, Krefeld (DE); Peter Meyer, Gelsenkirchen (DE); Michael Gerding, Bochum (DE); Gerd Stettin, Unterreichenbach (DE)

(73) Assignee: KROHNE MESSTECHNIK GMBH, Duisburg (DE)

(21) Appl. No.: 13/681,951

(22) Filed: Nov. 20, 2012

(30) Foreign Application Priority Data
Jul. 10, 2012 (DE) 10 2012 013 592.0

(51) Int. Cl. G06F 11/07

(52) U.S. Cl. CPC G06F 11/0751
USPC 714/799

(57) ABSTRACT

A method for transmitting data packets from a data source to a data sink with highest possible security in an energy efficient manner is obtained by at least two data packets are sent from the at least one data source to the at least one data sink, at least one of the at least two transmitted data packets being free of a single test value, the at least two data packets being sent from the at least one data source to the at least one data sink such that each of the at least two data packets received by the at least one data sink can be processed thereby essentially immediately after the reception of each data packet, and an overall test value for verifying integrity of a pre-defined number of associated data packets being transmitted to the at least one data sink from the at least one data source.

### BACKGROUND OF THE INVENTION

1. Field of the Invention

The invention relates to a method for transmitting data packets from at least one data source to at least one data sink, the at least one data packet being received and processed by the at least one data sink. Furthermore, the invention relates to a corresponding system with at least one data source and at least one data sink.

2. Description of Related Art

In order to ensure a secure transmission of data over a possibly unsafe data link, for example, so-called test values or checksums are used for comparison between transmitted and received data in the prior art. The probability that errors occur in the transmission is, in general, at least dependent on the error rate of the data link and the length and number of transferred data per unit time. In this case, the method used for generating the test value also affects the safety. However, the more complex the generation of the test value is, the more computing capacity is needed. If the data source and the data sink in particular are a measuring device, which, for example, is designed as a two-wire meter, the result is a capacity limitation, so that calculation methods not of arbitrary complexity due to the associated energy requirements can be applied.

### SUMMARY OF THE INVENTION

The primary object of the present invention is thus to provide a method for data transmission and a system of data source and data sink using this method, wherein the highest possible security of data transmission is achieved in an energy efficient manner.

The method according to the invention, in which above described object is achieved, is initially and essentially characterized by the following steps: at least two data packets are transmitted from the at least one data source to the at least one data sink. A data packet—also called a datagram, a segment, a block, a cell or a frame, depending on the protocol—is generally a self-contained unit of data that is sent from a data source as transmitter to a data sink as receiver and has a defined length and shape.

For the transmission method, at least one of the at least two data packets transmitted is free of a single test value used to verify an integrity of the associated data packet. Single test values are, in the simplest case, checksums, which are used for data integrity—i.e., the conformity between transmitted and received data—during data transmission. A test value or a checksum (the term “sum” is used in the prior art for test values arising from a more complex process than a cross-summation) is determined based on the data packet to be transmitted and, for data control, this test value is compared with the test value that is determined according to the same method of calculation for the received data packet. In the method according to the invention, at least one data packet is transmitted without such a single test value that would relate to this single data packet. This also means that the data sink for this single data packet cannot check the integrity via a test value, but this data packet is nevertheless already usable by the next feature of the transmission method for the data sink.

Thus, further in the method according to the invention, the at least two data packets are transmitted from the at least one data source to the at least one data sink in such a manner that each of the at least two data packets received by the at least one data sink is able to be processed by the at least one data sink, essentially immediately after receiving the respective data packet. Therefore, the individual data packets are not connected to a large data packet, whose individual data can be accessed only when the whole large data packet has been received, but instead each packet can already be used after its receipt, i.e., the data therein are usable for the data sink. In other words, the individual involved data packets in the prior art further remain individual data packets in the method according to the invention, but are transmitted without an associated test value that relates only to the individual data packet.

However, to ensure the security of the data transfer in the transmission method according to the invention, at least one overall test value used for verifying the integrity of a pre-definable number of associated data packets is transmitted from the at least one data source to the at least one data sink. Thus, an overall test value is transmitted from the data source to the data sink, this value referring to a pre-definable number of data packets. Since the plurality of the individual test values to be transmitted of the individual data packets is reduced with the method according to the invention to practically one overall test value, both computing capacity as well as the amount of data to be transmitted can be reduced.

The data sink must, therefore, based on the whole of the relevant received data packets, form an overall test value and compare it with the value that has been sent from the data source. Since computing capacity in the areas of data source and data sink and also data amount to be transmitted are reduced in the method according to the invention, a more complex method, for example, can be used for generating the overall test value than is used for generating the single test value. In this manner, the security of the transmission of the data is increased, even without the need for additional energy. All in all, energy can even be reduced compared to the prior art.

The method according to the invention is used, for example, between a data source and a data sink within a device, such as a measuring device for process automation, which is designed as a two-wire device. The data source and the data sink can thereby belong to a device and still be spatially separated. By limiting the energy available, preferably, the computing capacity for the detection of test values and the amount of data to be transmitted is to be reduced within the device. Thus, the method according to the invention, in particular, in such an implementation, has the advantage that a sufficiently high level of data security can be realized, even with reduced capacity, in an energy efficient manner.

In one design, data packets are transmitted from exactly one data source to exactly one data sink. This is, in particular, a point-to-point connection.

In one design, n data packets are sent from the data source to the data sink. The transmitted n data packets are free of a single test value used to verify an integrity of the associated data packet. The it data packets are sent from the data source to the data sink in such a manner that each of the n data packets received by the data sink is essentially processable by the data sink immediately after receiving each data packet. Furthermore, an overall test value used for verifying integrity of the n data packets is transmitted to the data sink from the data source. In this case, n is an integer greater than or equal to two.

The following two designs relate to the transmission of the overall test value. In one design, the overall test value is transmitted from the at least one data source to the at least one data sink after the transmission of the pre-defined number of data packets, on which the overall check value is based. In an alternative design, the overall test value is transmitted before the transmission of the pre-defined number of data packets. In a further design, the overall test value is transmitted between two data packets within the group of data packets, on which the overall test value is based.

In one design, the data packets are transmitted free of addressing. Addressing indicates which receiver, i.e., which data sink, the data packets are directed toward. In this design, addressing is omitted, which leads to a further reduction of the amount of transmitted data.

In one design, the overall test value is generated according to the cyclic redundancy method as a cyclic redundancy check (CRC) polynomial. The bit length of a CRC polynomial is equal to the largest exponent, i.e., to the degree of the polynomial plus one. In the prior art, the CRC polynomials are usually referred to as CRC-8, CRC-16, etc. The data length of a CRC-16 is therefore 17 bit. With increasing degree of the polynomial, data security is increased, at the same time, the required computing capacity also increases as well as the amount of data to be transmitted. The above-described transmission method, however, allows for generation of a much larger CRC value for the overall test value than would be realistic for individual packets because the single test values can be reduced. In one design, a CRC-32 or CRC-64 polynomial is used for the overall test value.

The above described object is met according to a further teaching of the invention with the aforementioned system in that the at least one data source and the at least one data sink are designed for the transmission of data packets according to one of the above designs of the method for transmitting data.

In one design, the data source is a sensor and the data sink is a converter. Application, here, is especially in the area of process and factory automation. The sensor is used, for example, for measuring and/or monitoring process parameters such as fill level, flow, pH, oxygen content or temperature. The data that are transmitted by the sensor are, for example, measurement data. The converter is again used, for example, for converting data into other formats for transmission to a control room or, for example, in 4 . . . 20 mA signals for signal output, or for the conversion using calibration details (e.g., conversion of distance data between sensor and fill level in the fill level height of a medium in relation to the bottom of the container, in which the medium is located).

In one design, the system is a two-wire measuring device. Supply of energy to the measuring device takes place via the interface, via which the output signal is output. The above method is used for data transmission within the measuring device.

The designs of the method described above can also be applied, in this case, in the system mentioned here, i.e., the remarks made in respect to the method apply here accordingly. Conversely, the designs of the system according to the invention can also be used for the method or, respectively, the remarks made are also valid in respect to implementation in the method according to the invention.

In detail, there are a plurality of possibilities for designing and further developing the method according to the invention and the system according to the invention, reference being made to the following description of embodiments in conjunction with the accompanying drawings.

### BRIEF DESCRIPTION OF THE DRAWINGS

FIG. 1 is a schematic representation of data transmission according to the prior art, indicating essentially the functional active correlations using a block diagram,

FIG. 2 is a schematic representation of data transmission according to the invention, indicating essentially the functional active correlations using a block diagram and

FIG. 3 is a schematic representation of a measuring device as system for data transmission with connection to a control room.

### DETAILED DESCRIPTION OF THE INVENTION

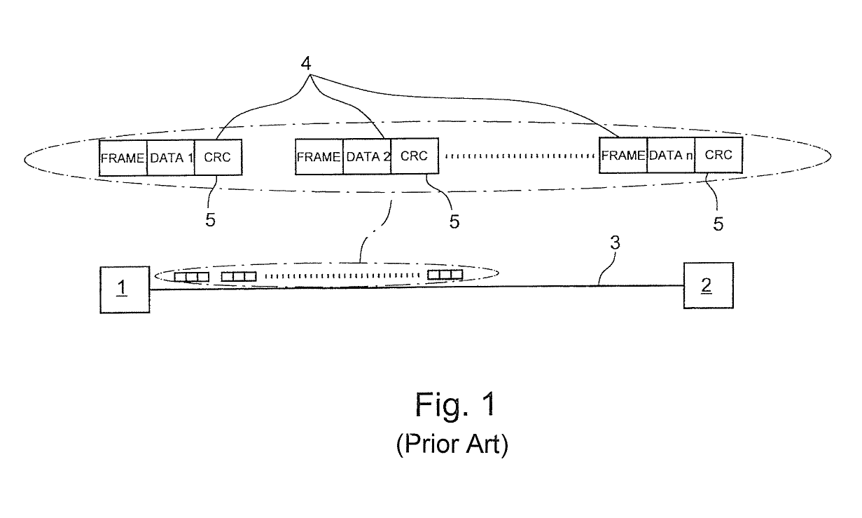

FIG. 1 shows a type of data transmission, as it takes place in the prior art, in which n data sets are transmitted from the data source 1 to the data sink 2 via a data link 3 (this can also be a wireless transmission link). Each of these n data (DATA1, DATA2 to DATAn) is in an individual data packet 4 sent from the data source 1 to the data sink 2. The data source 1 is, for example, a sensor, which generates measurement data for a process and transmits it to a converter as data sink 2. It is problematic when the data connection 3 is not safe or not safe enough for special applications with higher requirements. Therefore, the packets are each sent with a CRC signature. In the prior art, these are single test values 5, each of which relates only to the packet 4 to which it belongs. Also known in the prior art—but not shown—is that all data is sent in a single large packet. The individual data are, however, useable by the data sink 2 only when the overall data packet has been completely received.

If the security of the transmission should be increased, wherein the data link 3 itself remains unchanged, then, for example, the method used for generating the test value can be improved, e.g., the degree of the CRC polynomial is increased. However, this leads to the fact that the computing capacity increases and that more data must be transmitted. If the arrangement of data source 1 and data sink 2 is limited, specifically in power supply, then the degree of the polynomial cannot be increased arbitrarily. Consequently, data transmission as shown in FIG. 1 is limited in its data security.

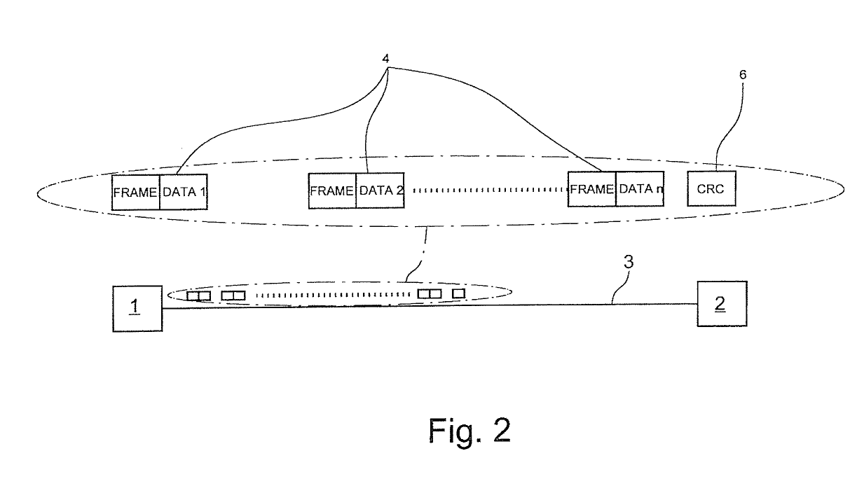

Data transmission according to the invention is shown in FIG. 2, which allows a higher data security even with a limited amount of energy. To achieve this, the data source 1 sends the data packets 4 without each packet being provided with a test value. Thus, the data packets 4 are smaller and the n single test values do not have to be calculated.

Energy saved in this manner is used to ensure that an overall test value 6 is generated—here for all n individual data packets 4—and transmitted via the data link 3 to the data sink 2. The more data packets 4 that are secured by the overall test value 6, the greater the savings in computing capacity and data amount to be transmitted, and thus, also the need for energy. As a result, the degree of the CRC polynomial can be increased by the amount of energy available for it.

The overall test value 6 is finally sent after the n data packets 4, but can also precede them or be scattered between two data packets 4. The data packets 4 reach the data sink 2 in such a manner that they are already usable by the data sink 2 after being received, so that there is no waiting for a large overall data packet so that there are no delays. The data packets 4 are, thus, complete.

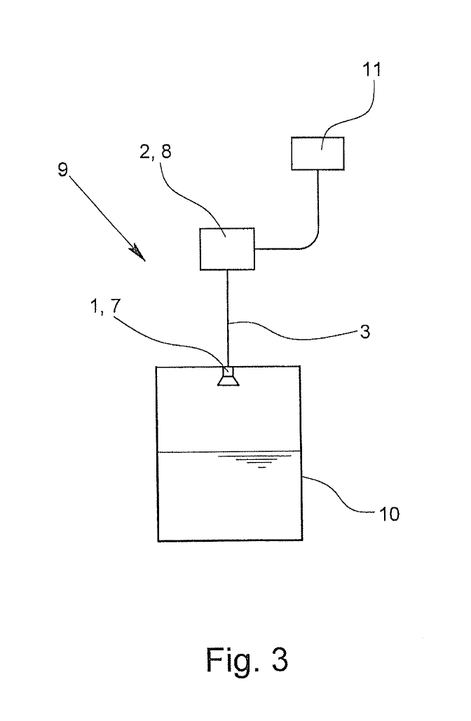

In FIG. 3, the data source 1 is a sensor 7 and the data sink 2 is a converter 8. Both are connected to one another by a cable as a data connection 3 and form in a system 9. The fill level of a medium in container 10 is monitored here by a (remote) sensor 7. Using the above-described method, the measured values reach the converter 8, which converts them based on stored calibration data into a suitable output format and transmits them to a control room 11 using a 4 . . . 20 mA signal. Alternatively, other protocols via different bus systems are possible. The measuring device, as a system 9 of a data source 1 or sensor 7 and data sink 2 or converter 8, in particular, is a two-wire measuring device with an associated principal energy limitation.

What is claimed is:

1. Method for transmitting data packets from at least one data source to at least one data sink, comprising the steps of:
transmitting n data packets from the at least one data source to the at least one data sink, n being an integer greater than or equal to two, at least one of the n transmitted data packets being free from a single integrity verifying test value, the at least two data packets being sent in such a manner that each of the at least two data packets can be processed by the at least one data sink essentially immediately after reception of each data packet, and
using an overall test value for verifying integrity of a pre-defined number of associated data packets, the overall test value being transmitted to the at least one data sink from the at least one data source.

2. Method according to claim 1, wherein data packets from exactly one data source are transmitted to exactly one data sink.

3. Method according to claim 2, wherein the n data packets are transmitted free from said single integrity verifying test value, wherein the n data packets are sent from the data source to the data sink in such a manner that each of the n data packets received by the data sink can be processed by the data sink essentially immediately after the reception of each data packet.

4. Method according to claim 1, wherein the overall test value is transmitted from the at least one data source to the at least one data sink after transmission of the pre-determined number of data packets.

5. Method according to claim 1, wherein the overall test value is transmitted from the at least one data source to the at least one data sink before transmission of the pre-determined number of data packets.

6. Method according to claim 1, wherein the data packets are transmitted free of addressing.

7. Method according to claim 1, wherein the overall test value is generated according to a cyclic redundancy method as a CRC polynomial.

8. System, comprising
at least one data source and
at least one data sink,
wherein the at least one data source is adapted for transmitting n data packets to the at least one data sink, n being an integer greater than or equal to two, with at least one of the n transmitted data packets being free from a single integrity verifying test value, and with each of the n data packets being in a form that is able to be processed by the at least one data sink essentially immediately after reception of each data packet, and
wherein the at least one data source is adapted for transmitting an overall integrity verifying test value to the at least one data sink for verifying integrity of a pre-defined number of the data packets.

9. System according to claim 8, wherein the data source is a sensor and the data sink is a converter.

10. System according to claim 9, wherein the system is a two wire measuring device.
